(19) United States
(12) Patent Application Publication
(10) Pub. No.: US 2014/0324904 A1
(43) Pub. Date: Oct. 30, 2014

(54) SIMILAR DESIGN STRUCTURE SEARCH DEVICE AND SIMILAR DESIGN STRUCTURE SEARCH METHOD

(71) Applicant: Hitachi, Ltd., Tokyo (JP)

(72) Inventor: Noriaki Yamamoto, Tokyo (JP)

(21) Appl. No.: 14/361,369

(22) PCT Filed: Oct. 11, 2012
(86) PCT No.: PCT/JP2012/076357

§ 371 Date: May 29, 2014

(30) Foreign Application Priority Data
Nov. 29, 2011 (JP) 2011-260468

(51) Int. Cl. G06F 17/30

(52) U.S. Cl. CPC G06F 17/30424
USPC 707/769

(57) ABSTRACT

Provided is design assistance technology capable of performing filtered detection on the basis of similar assembly structures when referencing past defect information and design improvement information at a design stage. In a similar design structure search device for an assembly configured by a plurality of components, the device has means for: acquiring component features of each component and adjacency relationships among components on the basis of 3D CAD data of an assembly configured by a plurality of components in order to store the same, as assembly structure data, together with past defect cases, design improvement cases, and manufacture instruction cases; and generating the assembly structure data on the basis of the 3D CAD data to be evaluated so that, when retrieving assembly structures similar to the stored case data, filtered detection is performed on the basis of a similarity assessment of two steps for component features and adjacency relationships.

### TECHNICAL FIELD

The present invention relates to a similar design structure search device and a similar design structure search method.

### BACKGROUND ART

The technique disclosed in Japanese Patent Laid-open No. 2010-244465 (herein shown as PTL 1) exists as an example of the background art of the present technical field. PTL 1 describes the technique as one for “providing a defect information storage unit into which the information relating to defects that have occurred in a design object in the past is stored in associated form with respect to basic parts and basic events, then identifying a part designated by search parameters, from part structural information, and deriving events that are likely to occur in the identified part, from part-event association information.”

The technique disclosed in Japanese Patent Laid-open No. 2000-222428 (herein shown as PTL 2) exists as another example of the background art. PTL 2 describes the technique as one intended to “calculate and assess levels of similarity between a search model and models to be searched for, then sort out search results in descending order of the similarity level, and output the results.”

The technique disclosed in Japanese Patent Laid-open No. 2008-117031 (herein shown as PTL 3) exists as yet another example of the background art. PTL 3 describes the technique as one for “creating an installation-enabling space shape from a shape of an installation-enabling space range and a shape of a design model; wherein a shape search unit extracts, from a part shape database, parts of a designated kind, the parts having a shape falling within the installation-enabling space shape that has been created.”

### CITATION LIST

### Patent Literatures

PTL 1: Japanese Patent Laid-open No. 2010-244465
PLT 2: Japanese Patent Laid-open No. 2000-222428
PTL 3: Japanese Patent Laid-open No. 2008-117031

### SUMMARY OF THE INVENTION

### Technical Problem

PTL 1 discloses a system in which the information relating to the defects of the past is identified from the part structural information as a method that enables selective searching only for information about defects that are likely to occur during design, even without entering a defect-causing event. The part structural information here, however, denotes a configuration of the parts contained in a subassembly, and does not allow for an assembly structure representing how individual parts are assembled with respect to each other. In addition, PTL 2 and PTL 3 disclose, as a search method based on created 3D CAD data, a search method of searching by model names or by part attribute information (drawing numbers, part types, part names, materials, and the like) registered for the model, and also disclose, as a method of searching for similar part shapes, a method of calculating in terms of the similarity level of a rectangular parallelepiped (hereinafter, referred to as bounding box) enveloping the part of interest. Both of the two patent literatures describe the search by part attributes or by part shapes. Since the search methods described in the two patent literatures are merely based on the attributes or shapes of parts and do not allow for an assembly structure of the plurality of parts, a filtered search relating to assembly work and manufacturing methods is considered not to be enough.

Accordingly, an object of the present invention is to provide a design support technique that enables one, when he refers to past defect information or design improvement information during a design phase, to selectively detect a desired assembly structure by assessing similarity in two steps, one by part features such as a part name, part type, or part shape, and one by adjacency relation including a relative direction of adjacency between parts.

### Solution to Problem

Provided in the present invention to solve the above problems is a similar design structure search device that searches for a past design case of an assembly structure by assessing similarity in two steps, one by designated part features and one by an adjacency relation including a direction of relative adjacency between parts, the device including: means that generates an assembly graph from a 3D CAD model; means that searches for a part similar to a part for which a search parameter is designated for each of case models registered in a case database; and means that extracts, from the part-to-part adjacency relation on the assembly graph as well as from the part searched for by the part search means, a candidate as a starting point of a search in at least one of the registered case models, and detects a similar structure matching an adjacency-relation filtering parameter set for each of cases on the basis of the starting point of the search.

Provided in the present invention to solve the above problems is a similar design structure search method designed to search for a past design case of an assembly structure by assessing similarity in two steps, one by designated part features and one by an adjacency relation including a direction of relative adjacency between parts, the method including the steps of: acquiring information on part orientations, geometric features, part attributes, and the adjacency relation between parts, from a 3D CAD model to be analyzed; generating an assembly graph from the acquired 3D CAD data, based upon an adjacency relation between parts of the assembly to be analyzed, as well as upon part features of the parts thereof; searching for a part similar to a part for which a search parameter is designated for each of case models registered in a case database; and first extracting, from the part-to-part adjacency relation on the assembly graph as well as from the part searched for in the part search step, a candidate as a starting point of a search in at least one of the registered case models, and then detecting a similar structure matching an adjacency-relation filtering parameter set for each of cases on the basis of the starting point of the search.

### Advantageous Effects of Invention

The present invention provides a design support technique that enables one, by using 3D CAD data, to analyze an adjacency relation between constituent parts, create an assembly graph, and extract an assembly structure similar to a case, based upon the adjacency relation and the assembly graph. Thus, he or she can refer to the information registered for the case (defects, design improvements, machining instructions, and the like), prevent defects from occurring, shorten the time spent in closely studying design improvements, and provide appropriate manufacturing instructions.

Other problems, constituent elements, and advantageous effects will be apparent from the following description of an embodiment.

### BRIEF DESCRIPTION OF DRAWINGS

FIG. 1 is an exemplary overall schematic block diagram of a design support device according to examples of the present invention.

FIG. 2 is an exemplary flowchart shown to describe generating a 3D CAD assembly graph and searching for similar structures according to Example 1.

FIG. 3 shows an example of a 3D CAD model information table stored within a storage of the design support device shown in FIG. 1.

FIG. 4 shows an example of a part type table stored within the storage of the design support device shown in FIG. 1.

FIG. 5A shows an example of a machining type table stored within the storage of the design support device shown in FIG. 1, and FIG. 5B shows examples of connection features shown in the table of FIG. 5A.

FIG. 6 shows an exemplary 3D CAD model.

FIG. 7 shows an example of an assembly graph generated in Example 1 for a better understanding of connection parts and with connection features added to a 3D CAD model shown in FIG. 5A,B.

FIGS. 8A,B are an explanatory diagram showing an exemplary method of reducing the number of nodes by transforming edges of part nodes, adjacent edges, and fastening part nodes.

FIG. 9 shows an example of a screen for registering case data.

FIG. 10 is an explanatory diagram outlining a method of extracting candidates as starting points of a search that have been set for various cases.

FIG. 11 is an explanatory diagram that outlines a process flowchart relating to narrowing down an adjacency relation.

FIG. 12 shows an example of a table for registering case data.

### DESCRIPTION OF EMBODIMENT

Hereunder, examples of the present invention will be described using the accompanying drawings.

### Example 1

The present example of the present invention is a similar design structure search device configured to search for a design structure that uses 3D CAD data to create a data representation of part features and an adjacency relation between parts, as an assembly graph, and to search for past case information relating to the design structure.

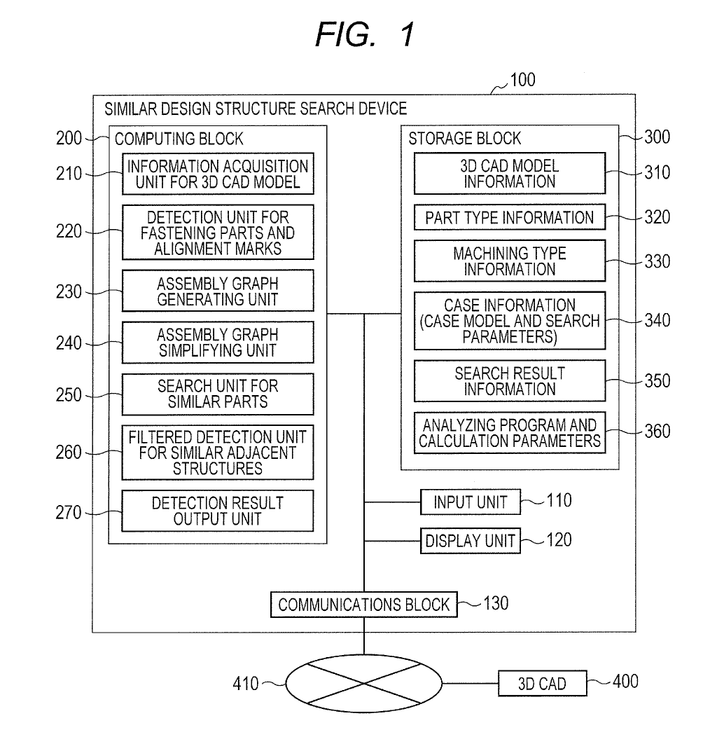

FIG. 1 is an exemplary functional block diagram showing schematically a similar design structure search device applied to various examples of the present invention. Essential elements of the similar design structure search device 100 include the following: an input unit 110 such as a keyboard or mouse, which is used to enter setup information necessary for analysis, and to enter selection instructions or other instructions into menus; a display unit 120, which displays an object model, entered information, process results, a historical background of the ongoing process, and other information; a computing block 200, which realizes various processing functions of the present invention by executing programs; a storage block 300, which stores various information and programs; and a communications block 130, which receives CAD model information from 3D CAD 400 via a network 410.

The storage block 300 mainly includes a 3D CAD model information storage unit 310, a part type information storage unit 320, a machining type information storage unit 330, a case information storage unit 340, a search result information storage unit 350, and an analyzing program/calculation parameter storage unit 360. The storage block 300 is constituted by, for example, a read-only memory (ROM), a random access memory (RAM), and an external storage device.

The computing block 200 includes the following: an information acquisition unit 210 for a 3D CAD model, a detection unit 220 for fastening parts and alignment marks, an assembly graph generating unit 230, an assembly graph simplifying unit 240, a search unit 250 for similar parts, a filtered detection unit 260 for similar adjacent structures, and a detection result output unit 270.

The input unit 110 may be a touch panel, a special switch and sensor, or a voice recognition device. The display unit 120 is, for example, a display, a projector, a head-mounted display, or any other appropriate device that makes an onscreen display of information. A printer (not shown) that prints out the information displayed on the display unit 120 onto sheets of paper may be connected to the similar design structure search device 100.

These hardware units do not need to be dedicated ones for the present example and may be a general computer system such as a personal computer.

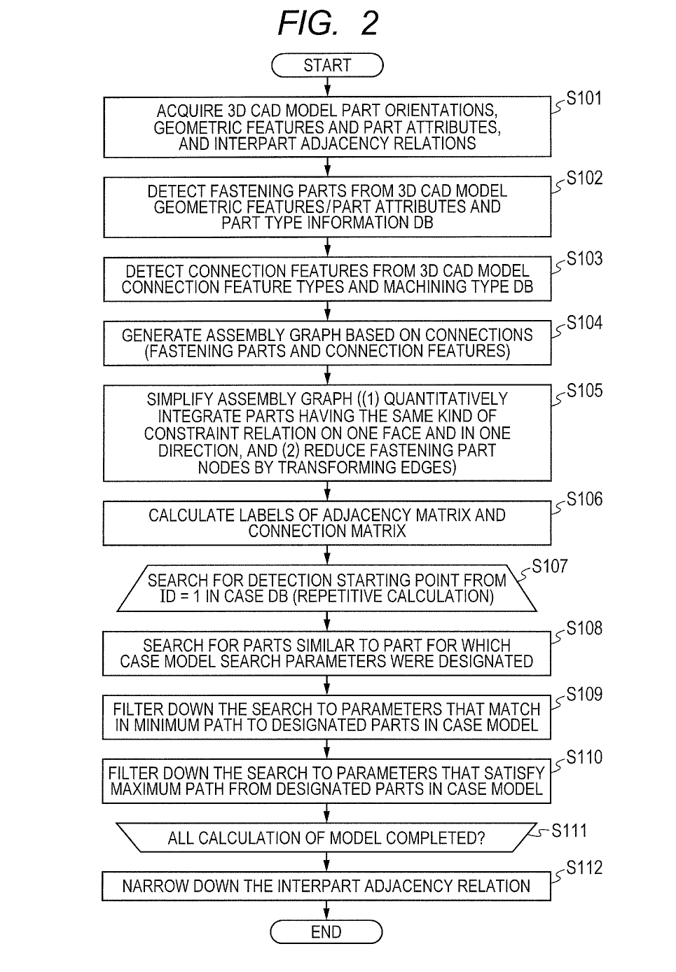

FIG. 2 is an exemplary flowchart shown to describe a process down to the step of generating an assembly graph based on 3D CAD data, and the step of identifying parts that match search parameters which have been set for a case model.

In step S101, the information acquisition unit 210 for a 3D CAD model (a model to be analyzed: an assembly), in the computing block 200, acquires information on part orientations, geometric features and part attributes, and adjacency relations between parts, from the 3D CAD model to be analyzed, and stores the information into the 3D CAD model information database (DB) 310 of the storage block 300.

The above process assumes that the object to be analyzed is an assembly model, an assembly consisting of a plurality of parts. Operations for creating the 3D CAD model and operations for designating the model to be analyzed are omitted from the flowchart of FIG. 2.

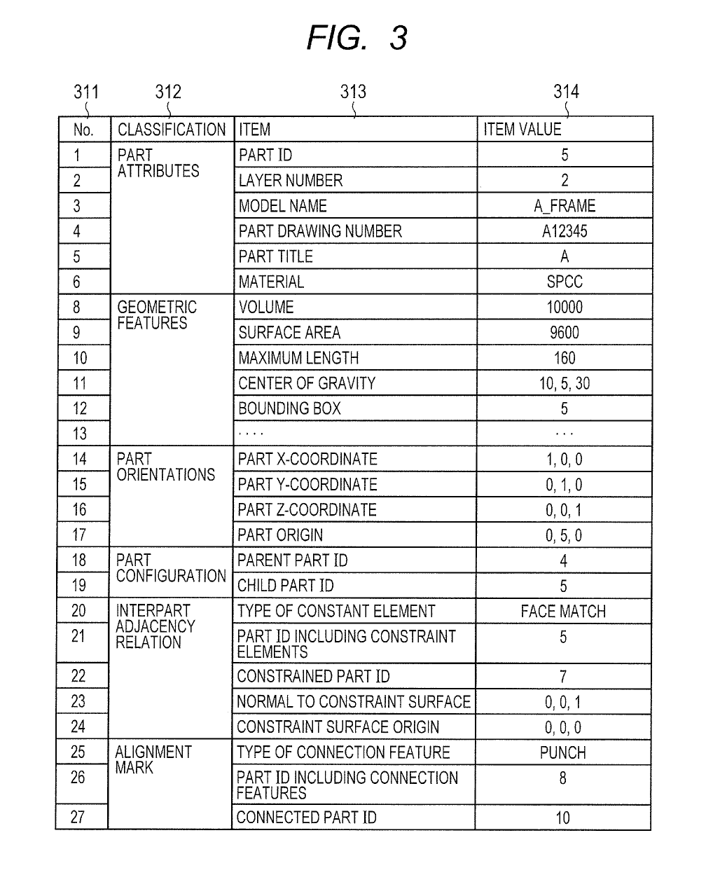

FIG. 3 shows exemplary constituent items of a table for describing information 310 on the acquired 3D CAD model. The table is constructed of a data record with columns of data No. 311, a classification 312, an item 313, and an item value 314. The classification 312 consists of a classification of part attributes, geometric features, part orientations, a part configuration, an interpart adjacency relation, and alignment marks. Part IDs that identifies parts and subassemblies uniquely in the 3D CAD model are set and specific information for each of the part IDs is stored.

The part attributes are the part IDs, a (hierarchical) layer number that denotes the configuration of parts on the 3D CAD model, a name of the model, a drawing number of the part, a title of the part, the kind of material used, and other information. The geometric features are a volume, a surface area, maximum length, a center of gravity, and other information. A bounding box (coordinates of eight vertexes of a rectangular parallelepiped which serves as a boundary enveloping the part in a part coordinate system), a principal moment of inertia, principal axes of inertia, mass, and other information may also be used.

The part orientations are positions and postures/attitudes of the parts on the assembly model, arranged in a world coordinate system, and consist of three axes, X, Y, and Z, of the part coordinate system of the parts, and an origin of the part.

The part configuration is information that denotes parental relations between the subassemblies and parts of the 3D CAD model.

The interpart adjacency relation is assembly constraint information that is set when the assembly model is created, and this information includes a constraint element type, a part ID including a constraint element, a part ID constrained (constrained part ID), a constraint surface normal line representing a constraint surface, and a constraint surface origin. In addition, acquisition of the assembly constraint information may, or preferably should, use a scheme in which the information is acquired not only when set by a designer during modeling, but also by conducting a clearance analysis between parts, based on the assembly model. One method of the clearance analysis is by searching for another model present within clearances of various surfaces of the parts modeled on the basis of set threshold values, and then acquiring position and orientation information on adjacent part surfaces (planes, cylindrical surfaces, conical surfaces, and the like) as a result of the search.

The acquisition of the constraint surface information based on the assembly constraint and clearance analytical information assumes that for a plane, a point on the plane and a constraint surface normal-line vector directed outward of the model is set as the constraint surface origin, and that for a cylindrical surface, a point on an axis of the cylinder is set as the constraint surface origin with a constraint surface normal-line vector in an axial direction of the cylinder.

In step S102, the detection unit 220 for fastening parts and alignment marks, in the similar design structure search device 100, detects fastening parts from the geometric features/part attributes of the 3D CAD model and the part type information DB 320.

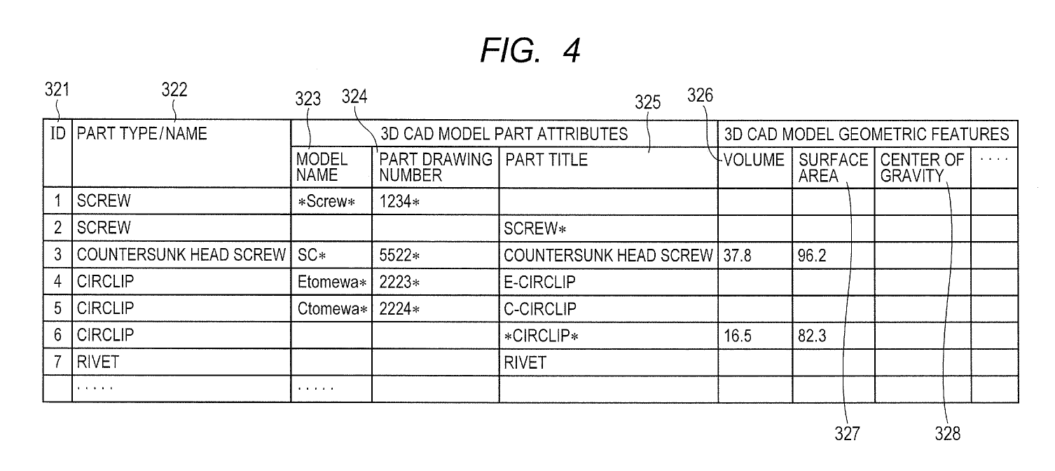

FIG. 4 shows an example of a table structure for describing the part type information DB 320 of the storage block 300. The table has information items of a part type ID 321, a part type name 322, part attributes of the 3D CAD model (i.e., a model name 323, a part drawing number 324, and a part title 325) as information for assigning a part type, and geometric features of the 3D CAD model (i.e., a volume 326, a surface area 327, a center of gravity 328). The table is constructed to identify the part by the part type name and the part type ID, depending on line-by-line assigning parameters. In the example of FIG. 4, in the line-by-line assigning parameters, the search takes place with non-blank items as parameters. The part drawing number 324 and the part title 325 constitute text information that a user has arbitrarily defined for the part model or assembly model of the 3D CAD model. In the 3D CAD model name, the part title, and other part attributes consisting of character strings, the assignment may be conducted upon a partial match, as well as upon an exact match of all character strings. When a character string is stored, a wildcard character, such as an asterisk (*), that denotes a given character may be contained in the character string. A character string parameter column may be added to define parameters such as an exact match, forward match, and backward match. In addition to the above, the vertexes of the bounding box in the part model, the principal moment of inertia, and other mass characteristics acquirable by calculating the 3D CAD model may be stored as geometric features.

The part type of a fastening part is recognized for a part that matches columns located to the right of the part type name column. Empty cells are optional and the search is conducted by setting an AND parameter under each column. An OR parameter is set by defining a plurality of lines with a predetermined column as an empty cell.

In step S103, the detection unit 220 for fastening parts and alignment marks, in the similar design structure search device 100, detects part IDs associated with connection features, from a connection feature type of the 3D CAD model and the machining type information DB 330.

The 3D CAD model information DB 310, the part type information DB 320, and the machining type information DB 330 denote the information stored on a hard disk.

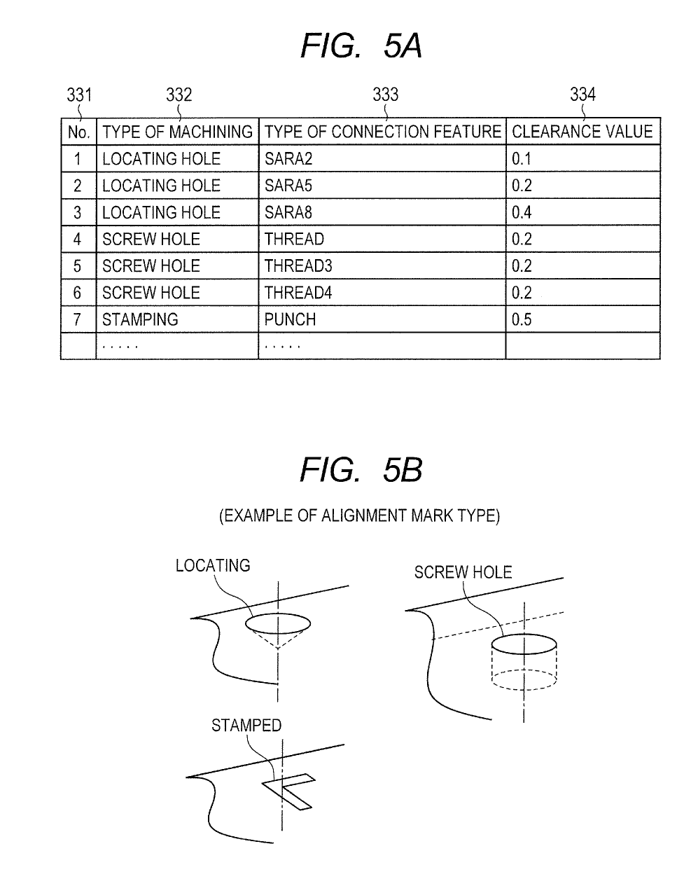

FIG. 5A shows an example of a table structure for describing the machining type information DB 330 of the storage block 300. In this table, the machining type is assigned with the connection feature name of the 3D CAD model. It is assumed that a clearance value 334 is stored for each connection feature and that the stored clearance value 334 is taken as a threshold value to be used when adjacent parts are detected. FIG. 5B shows a locating hole, a stamped portion, a screw hole, and the like, as examples of alignment mark types (connection feature information).

When adjacent parts within the clearance value that has been set for the connection feature are detected, as this method, at least one point or three equally spaced calculation object points are set on a surface edge of the designated connection feature and then the search is conducted for surfaces adjacent to each other within the clearance value, at the particular point(s). In this search, in the bounding box of the parts contained in the model to be analyzed, if a sphere whose radius is equal to the clearance value with the calculation object point(s) as a center is not included, the part is excluded from the search. If a part having adjacent surfaces within the clearance value is found as a result of the point-and-surface search, that part is identified and the adjacent surfaces are identified. The normal-line direction of the connection feature surface is stored as a direction in which the part is disassembled. In addition, if as described above, a relation to one part is detected on the basis of the three points on one connection feature, the relation is identified as one piece or item of adjacency relation information denoting a representative point of the connection feature, such as a center point. When a clearance analysis is conducted for all surfaces in this way, a time required for the analysis can be significantly reduced by analyzing adjacent connections in filtered/narrowed form and by conducting the adjacent point-to-surface analysis, not an adjacent surface-to-surface analysis. Furthermore, during analysis of all surfaces, a need may often arise for one to perform a surface analysis unnecessary for determining whether the model has adjacent parts such as a fillet and chamfer, but if the connection feature is designated beforehand and adjacent parts are searched for on the basis of a point on an edge of the surface, that unnecessary search can be skipped and search noise reduced.

In step S104, the assembly graph generating unit 230 of the similar design structure search device 100 generates an assembly graph based on connections (fastening parts and connection features). The assembly graph denotes a graphically represented data structure with part features (the model name, the part type, the kind of material, and other part attributes and geometric features) as nodes, and interpart adjacency relations as edges.

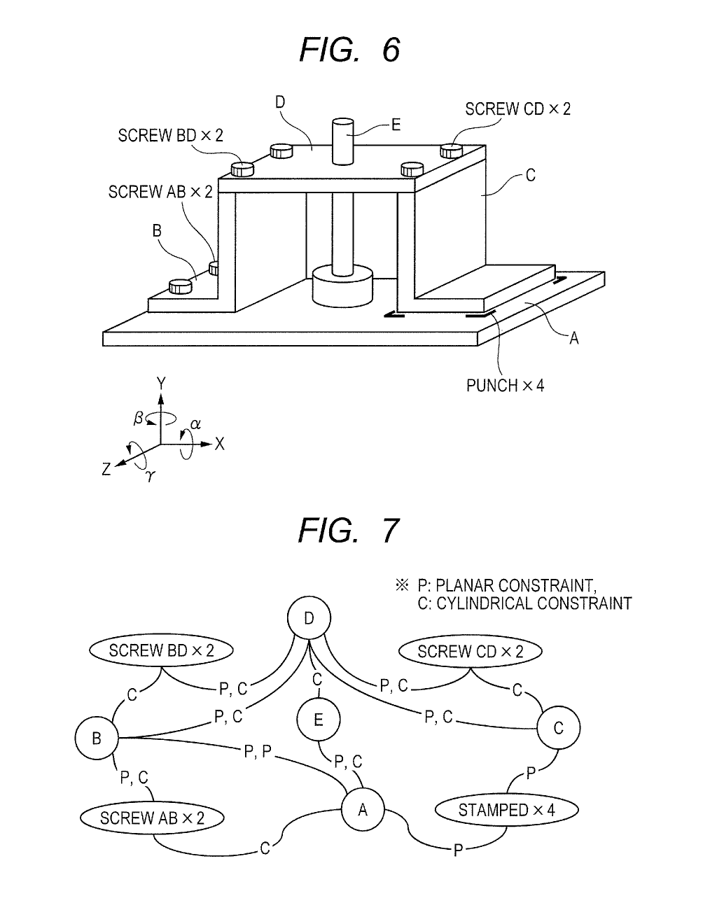

This data structure is described below using a model shown in FIG. 6. The model in FIG. 6 is an assembly including constituent parts A, B, C, D, and E and screws AB, BD, and CD. The assembly also includes a stamped portion (connection feature: PONCH) as an alignment mark, in each of four places on an upper surface of part A and a lower surface of part C. While parts of the same part title and the same connection feature are each shown with “×quantity” (pieces), for example as screw AB×2, in the figure, the respective part information is managed with a unique part ID, as shown in FIG. 3.

FIG. 7 shows an example of an assembly graph generated from the interpart adjacency relations in a 3D CAD model. An axial match (C: cylindrical constraint), planar match (P: planar constraint), etc. of a cylinder are identified as constraint element types from the interpart adjacency relations in FIG. 3 and parts adjacent to the alignment marks (connection feature) described in FIG. 5A,B. In addition, a relation between parts is identified from the part ID including a constraint element, and the constrained part ID. Furthermore, directions in which the elements are adjacent are identified from the constraint surfaces and related normal-line vectors. Thus as shown in FIG. 7, the assembly graph can be output in the graphically represented form with the part features as nodes and the interpart adjacency relations as edges.

Parts A and C in FIG. 6, stamped at the alignment marks in the four places, are fixed by welding. In this case, as shown in FIG. 3, the connection feature PONCH that denotes location is modeled for part A of the part ID 5 including the connection feature, and is determined to have a relation with a connected part ID 10. Additionally, the machining type of the connection feature PONCH is identified as stamping and the clearance value is identified as 0.5 from the machining type information DB 330 in FIG. 5A. Furthermore, the information relating to parts adjacent to the stamped portions is acquired and adjacency relations to part A are determined to exist.

When the adjacency relations to the alignment marks are analyzed, at least one point or three equally spaced points are set on an edge of an alignment mark modeling sketch surface and then after the search for the surfaces of other parts that are adjacent within the clearance value, at the particular point(s), the adjacent parts are identified. The directions in which the parts are adjacent to each other are defined in respective IDs as the directions in which the parts are to be assembled and fastened from the shape of the alignment marks. For example, a normal-line direction exiting outward from the surface, in the axial direction of the cylinder, is defined for a screw hole. In addition, a normal-line direction exiting outward with respect to the sketch surface is defined for a stamped portion. At an alignment mark, for a shape of a through element as with a hole of a cylindrical shape, a similar search for a surface adjacent within the clearance value relative to the point on the edge is conducted at the surface of the opposite side as well, and the adjacent parts are identified.

In this way, the adjacency relations are acquired based on the connection feature in addition to the match/constraint information that was set during modeling. The assembly graph that does not depend upon modeling can therefore be generated.

In step S105, the assembly graph is simplified. More specifically, if the part node, the adjacency relation, and the constraint relation are all the same, the corresponding parts are quantitatively integrated with the same part title and collectively represented as one part node and/or one edge. In the example of FIG. 6, screws AB, BD, and CD have constraint relations of the same part title and the same direction, and hence, the quantity of two pieces is represented as “×2” for each kind of screw. The stamped portions also have constraint relations of the same direction and are therefore represented as “×4.”

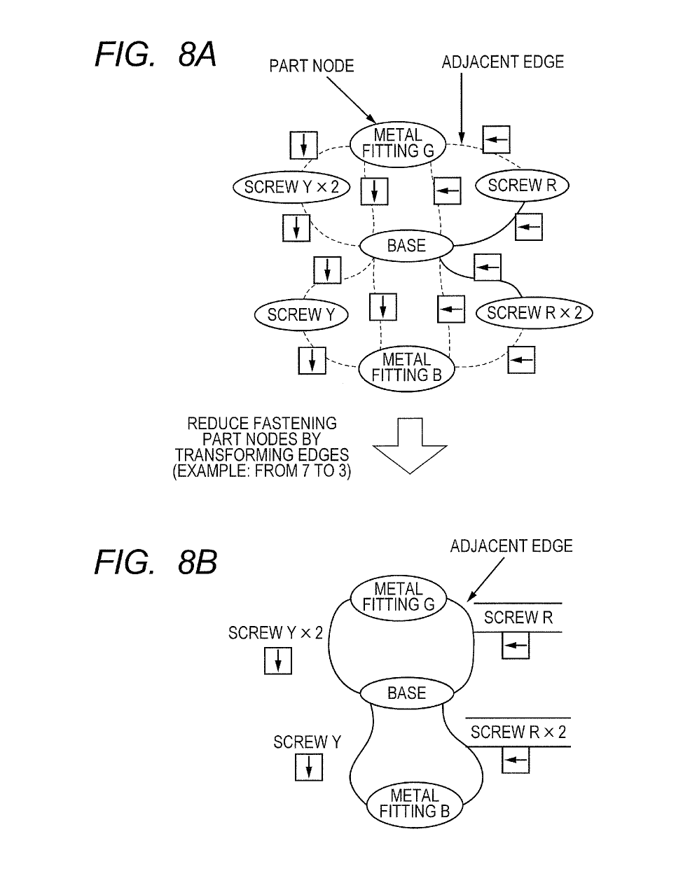

Another example of assembly graph simplification with attention focused upon fastening part nodes is shown in FIG. 8A,B. FIG. 8A shows an example of simplification by the integration described above. Part nodes denote oval elements, and adjacent edges denote the adjacency relation between the parts. Screws R and Y in the figure are fastening parts. An arrow above the adjacent edges signifies a direction of adjacency. At the fastening part nodes, attention is focused upon the adjacent edges of the same direction and the adjacent edges each including one fastening part node are transformed into one adjacent edge. This state is shown in FIG. 8B. The number of nodes in the fastening parts can be reduced by the transformation. Assembly-type products contain fastening parts at high rates of 30 to 80%. Execution of the above simplification means enables reduction in a size of a to-be-calculated assembly graph according to the particular rate of fastening parts, and hence, significant reduction in calculation time.

In step S106, attributes associated with an adjacency matrix, which represents what/which parts are adjacent to the part nodes in the generated assembly graph, and with a connection matrix, which represents in what relationship the edges extending from the part nodes (i.e., adjacency relations) exist, are called labels, and these labels are calculated. One label for the adjacency matrix is information representing the relationship between any two part nodes. The label also constitutes information denoting the number and kind of edges extending from a part node, a classification of adjacent parts, and more. To be more specific, in the example of FIG. 7, one D-part node includes five edges, three adjacent parts, and two fastening parts.

One label for the connection matrix is information denoting the relationship between any two edges, and denotes an angle of the constraint surface normal line constituting the two edges, an orientation relation (shortest distance, longest distance, and edge-to-edge relationship) of a point sequence of constraint points constituting the surfaces, and more. In the example of FIG. 7, for example, the angle formed by edges “D-E” and “D-C” is 0 degrees and the angle formed by edges “D-B” and “D-C” is 0 degrees.

In step S107, the calculation process in next step is conducted upon all the registered sets of case information in the case information DB 340 in order with the first case model first.

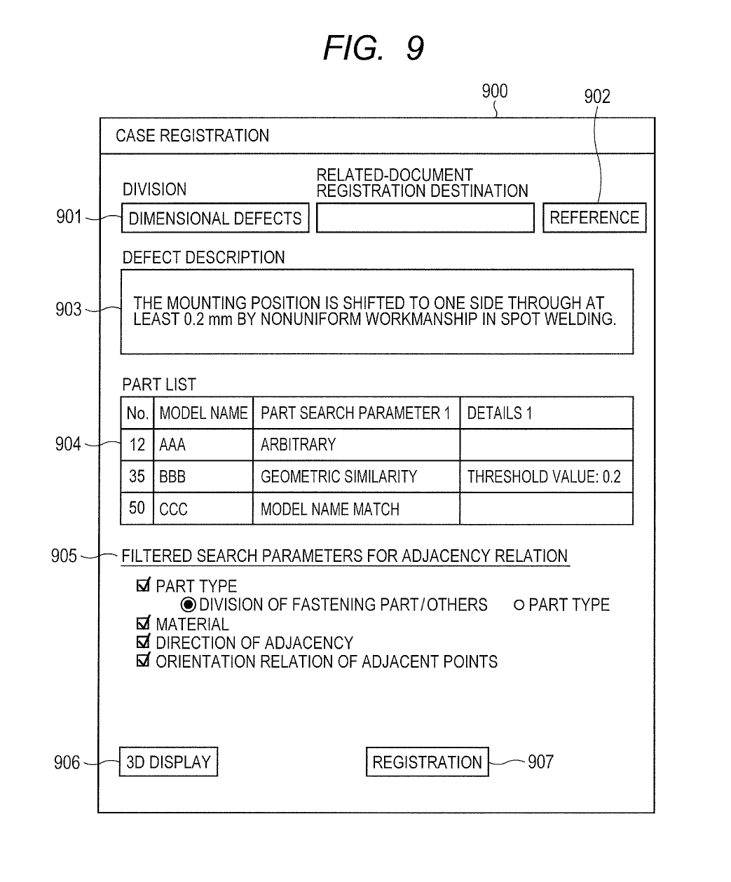

In step S108, the search unit 250 for similar parts searches for parts similar to the part for which the search parameters were designated at the case model side. FIG. 9 shows an example of a screen 900 for registering case data. This example relates to registering a defect case when the part information shown in FIG. 3 is output from the 3D CAD model. In this example, defect division 901 (a defect in dimensions, a defect in specifications, inappropriate selection of a material, or the like), related-document registration destination 902 (URL and/or a storage destination file path), defect description 903, and minimum necessary part configuration list 904 relating to the defect are registered as a case model.

In this step, prior to selection of the minimum necessary part configuration from the 3D CAD model, preferably a model tree of the 3D CAD model is first displayed and a desired range of this model tree is designated for extraction of a part list shown in FIG. 9. For reconfirmation of the selected part configuration, after activation of 3D CAD by a click of a “3D display” button 906, only the selected part list is displayed and all other parts are hidden. The reconfirmation is now possible, and can be realized by, when acquiring information from 3D CAD, saving a storage destination directory path for the model file, an updating date/time of the model, and the IDs of the part models. In addition, part search parameters are designated in the registration destination part list. More specifically, geometric similarity, an exact model-name match, a partial model-name match, a kind-of-material match, kind-of-material similarity, bounding box size similarity, maximum length similarity, and the like are designated as the parameters. This, in turn, also enables a filtered search in combination of the parameters.

Geometric similarity is assessed using the characteristics data based on mass characteristics such as a surface area, volume, mass, center of gravity, and principal axes of inertia, in addition to using simply the dimensions and maximum length in the bounding box. Threshold values for the similarity assessment can also be set. Additionally or alternatively, to assess similarity between character strings, the Rubenstein distance or the Hamming distance may be calculated as an additional parameter for character string similarity assessment, in addition to an exact match, a forward match, a backward match, and a partial match, and the characteristics data obtained from the calculation may be applied to the similarity assessment.

The part model for which the thus-registered case model search parameters were set is searched for in all part models constituting the model to be assessed. Thus the part node to become the starting point of the search for the adjacency relation can be found.

In addition, as shown in FIG. 9, item 905 “Filtered search parameters for adjacency relation” is set for each case. These parameters are for filtering down an adjacent node existing beyond the starting point. For a parameter of “Division of fastening part/others,” for example, after recognition of fastening parts in the table of FIG. 4, it is determined whether the adjacent part node is a fastening part. For a parameter of “Part type,” whether the adjacent part node is of the same part type as that of the case is determined more precisely. For a parameter of “Material,” it is determined whether the adjacent part node is of the same material as that of the case. For a parameter of “Direction of adjacency,” it is determined whether the adjacent part node is in the same direction as that of the case. This determination means calculating in all combinations the angle formed between two edges, and determining whether each combination angle at the case side is included. Calculated angles are divided into 0 degrees, 45 degrees, 90 degrees, 135 degrees, and 180 degrees, to prevent a detection omission due to a slight difference in angle. For a parameter of “Orientation relation of adjacent points,” whether acquired adjacent points are in the same kind of orientation relation as that of the case is determined by making calculations for each adjacent surface as to whether the adjacent points are arranged rectilinearly, arranged on an arc, or arranged on a grid. If these filtered-search parameters are selected in plurality, the search takes place with an AND parameter. For example, for a case selected by selecting all of “Part type,” “Material,” “Direction of adjacency,” and “Orientation relation of adjacent points” and clicking on a registration button 907, “Part type-Material-Direction of adjacency-Orientation relation of adjacent points” is recognized as a string of successive characters in the adjacency relation from the starting point. In this case, the elements matching (included in) the combination are left. Thus the filtered detection of the adjacent elements takes place.

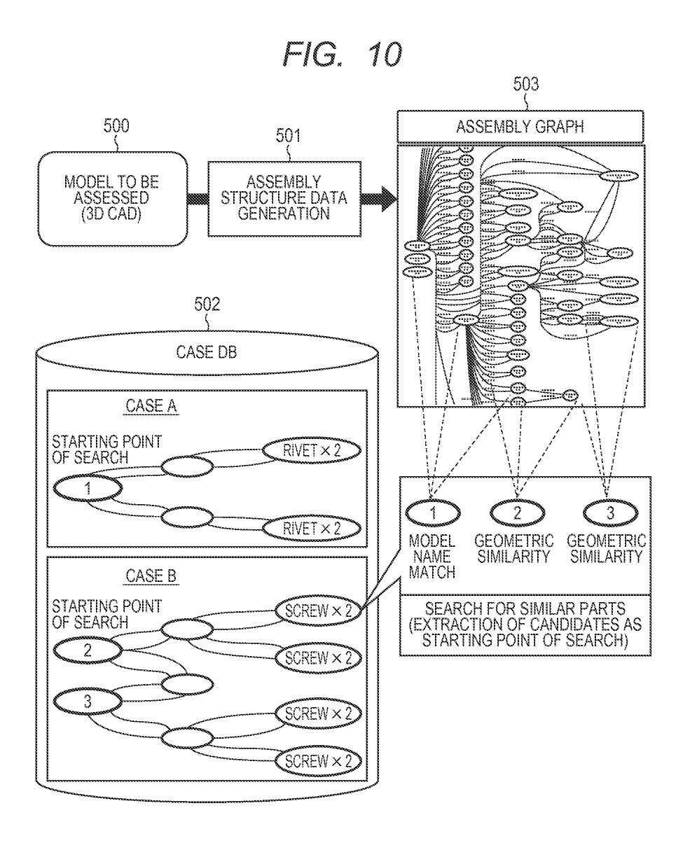

FIG. 10 shows an outline of a process flow from generating (501) an assembly graph 503 as an assembly structure from a model to be assessed (3D CAD) 500 in a case-by-case assembly graph registered in a case, to executing a similar-part search, based on corresponding parts and adjacency relations, from the starting points of the search that are registered in the case DB 502. In this manner, candidates as the starting points of the search, in the model to be assessed, are extracted in accordance with the case-by-case starting point search parameters set on the case registration screen of FIG. 9 and in accordance with parameters such as model-name match and geometric similarity.

In step S109 of FIG. 2, if a search parameter is found to have been set for a plurality of parts in one case model, only the elements satisfying the minimum path between the plurality of parts (i.e., a minimum value of the nodes existing between any two part nodes) are filtered down and elements not matching the case are excluded from subsequent processing. In step S110, only the elements satisfying the maximum path from the part for which the search parameter has been designated are filtered down and elements not matching the case are excluded from subsequent processing (step S111). Through these process steps, the part node to become the starting point of the search that matches the case in the model to be assessed can be filtered down. In step S112, the adjacency relation from the node that has been extracted as the starting point of the search is analyzed. Only the elements including the adjacency relation of the case are left and all mismatch elements are excluded from processing.

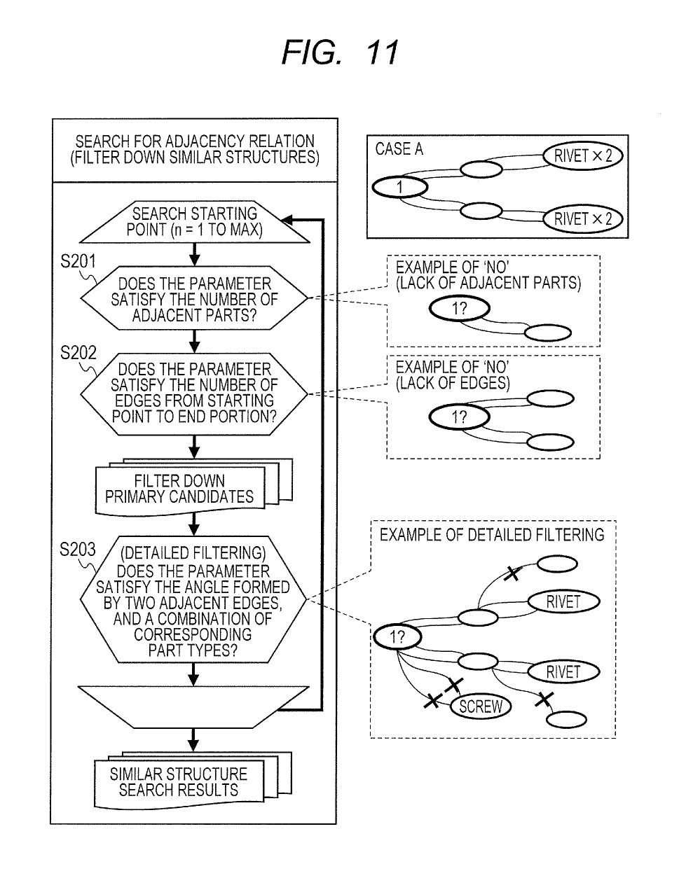

FIG. 11 is an explanatory diagram that outlines the flowchart relating to detailed filtering of the above adjacency relation. On the basis of the starting point of the search that was detected in FIG. 10, the filtered detection unit 260 for similar adjacent structures uses case-by-case set adjacency relation filtering parameters to conduct determinations on edges adjacent to the part nodes beyond the starting point. For example, it is determined as primary filtering whether the number of adjacent parts is satisfied (step S201), and whether the number of edges from the starting point to an end portion is satisfied (step S202). After the above primary filtering of candidates, in accordance with adjacency relation filtering parameters, it is determined as detailed filtering in step S203 whether the angle formed between two edges is satisfied and whether the combination of corresponding part types is satisfied. At least one similar structure is detected by repeating the above determination process at all the starting points of the search that have been detected as candidates.

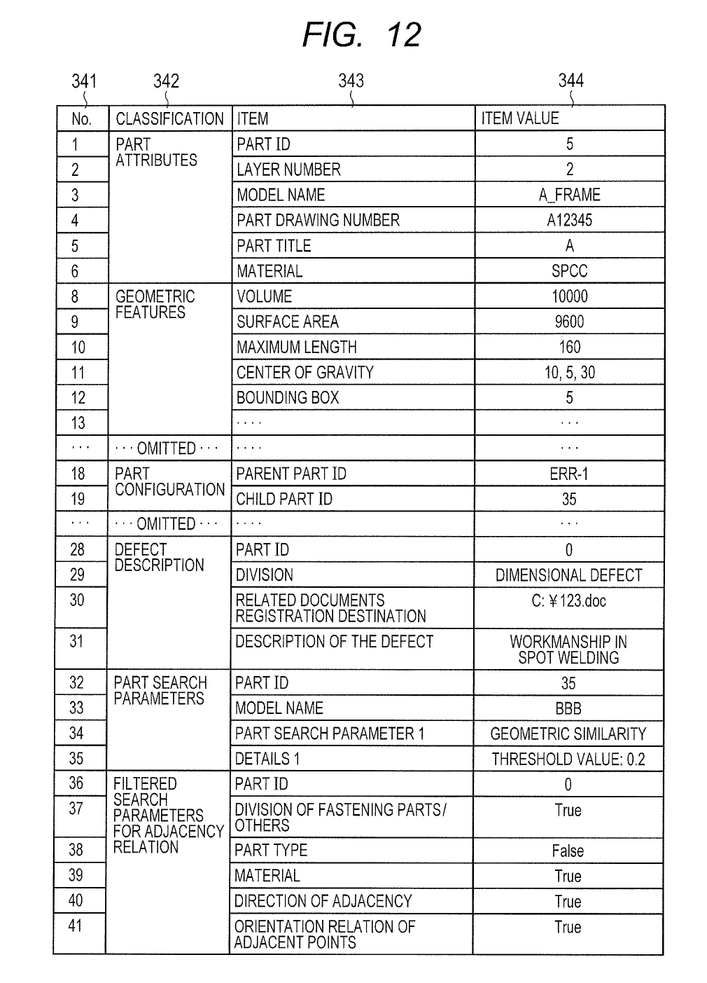

In addition to the defect description item in FIG. 9, the case model information is substantially the same as the information shown in FIG. 3 as a necessity for the generation of the assembly graph. The search parameters that were set on the screen of FIG. 9 are added to that information before the search parameters are stored into the relevant DB. FIG. 12 shows registration information of a defect case. Sections common to those of FIG. 3 are omitted in FIG. 12.

The defect description shown in FIG. 9 is information that relates to the entire case, so that this information is registered with part ID=0. The part configuration that has been selected as the case (i.e., the part list in FIG. 9) is stored as a part configuration with a parent part having a defect case identification (ID), and the selected part as a child part. In addition, part search parameters are registered in accordance with the parameters that have been set for the parts within the part configuration. Furthermore, filtered search parameters for adjacency relation are parameters that relate to the entire case, so that this parameter information is registered with part ID=0.

It is to be noted that the present invention is not limited to the aforementioned examples, but covers various modifications. While, for illustrative purposes, those examples have been described specifically, the present invention is not necessarily limited to the specific forms disclosed. To cite an example, while the example is of a scheme in which it is detected whether an assembly structure similar to a case represented by the case information denoting the assembly structure where a defect has occurred in the past is included in a new design model, this scheme may be replaced by a scheme in which, after a case model of an assembly structure requiring detailed design documentation on assembly structures as well as on geometric analyses such as tolerance analyses has been registered as case information, an assembly structure similar to the case model is detected and then presented to a designer to notify that detailed design documents are needed. In addition, partial replacement is possible between the components of a certain example and the components of another. Likewise, certain components can be added to or removed from the examples disclosed.

Note also that some or all of the aforementioned components, functions, processors, and the like can be implemented by hardware such as an integrated circuit or the like. Alternatively, those components, functions, and the like can be implemented by software as well. In the latter case, a processor can interpret and execute the programs designed to serve those functions. The programs, associated data tables, files, and the like can be stored on a stationary storage device such as a memory, a hard disk, and a solid state drive (SSD) or on a portable storage medium such as an integrated circuit card (ICC), an SD card, and a DVD.

Further note that the control lines and information lines shown above represent only those lines necessary to illustrate the present invention, not necessarily representing all the lines required in terms of products. Thus, it can be assumed that almost all the components are in fact interconnected.

### REFERENCE SIGNS LIST

100 . . . Similar design structure search device
110 . . . Input unit
120 . . . Display unit
130 . . . Communications block
200 . . . Computing block
210 . . . Information acquisition unit for 3D CAD model
220 . . . Detection unit for fastening parts and alignment marks
230 . . . Assembly graph generating unit
240 . . . Assembly graph simplifying unit
250 . . . Search unit for similar parts
260 . . . Filtered detection unit for similar adjacent structures
270 . . . Detection result output unit
300 . . . Storage block
310 . . . 3D CAD model information storage unit
320 . . . Part type information storage unit
330 . . . Machining type information storage unit
340 . . . Case information storage unit
350 . . . Search result information storage unit
360 . . . Analyzing program/calculation parameter storage unit
400 . . . 3D CAD
410 . . . Network
500 . . . Model to be assessed (3D CAD)
501 . . . Assembly structure data generation
502 . . . Case DB
503 . . . Assembly graph
900 . . . Case registration screen
901 . . . Division display region
902 . . . Related-document registration destination
903 . . . Defect description input region
904 . . . Minimum necessary part configuration list
905 . . . Filtered search parameters for adjacency relation
906 . . . 3D display button
907 . . . Registration button

1. A similar design structure search device configured to search for a past design case of an assembly structure by assessing similarity in two steps, one by designated part features and one by an adjacency relation including a direction of relative adjacency between parts, the similar design structure search device comprising:
means that generates an assembly graph from a 3D CAD model;
means that searches for a part similar to a part for which a search parameter is designated for each of case models registered in a case database; and
means that extracts, from the part-to-part adjacency relation on the assembly graph as well as from the part searched for by the part search means, a candidate as a starting point of a search in at least one of the registered case models, and detects a similar structure matching an adjacency-relation filtering parameter set for each of cases on the basis of the starting point of the search.

2. The similar design structure search device according to claim 1, wherein:
the means that generates the assembly graph focuses attention upon the fastening part and the connection feature and acquires a fastening direction by acquiring a direction of a line normal to an adjacent surface.

3. The similar design structure search device according to claim 1, wherein:
from among at least of an external size value of a bounding box, a center of gravity, principal axes of inertia, a volume, a surface area, a part name, a model name, and the kind of material, at least one part attribute is registered as a search parameter for the designated part registered in the case database.

4. A similar design structure search method designed to search for a past design case of an assembly structure by assessing similarity in two steps, one by designated part features and one by an adjacency relation including a direction of relative adjacency between parts, the similar design structure search method comprising:
a step, executed by a model information acquiring section, of acquiring information on part orientations, geometric features, part attributes, and the adjacency relation between parts, from a 3D CAD model to be analyzed;
a step, executed by an assembly graph generating section, of generating an assembly graph from the acquired 3D CAD data, based upon an adjacency relation between parts of the assembly to be analyzed, as well as upon part features of the parts thereof;
a step, executed by a similar parts search section, of searching for a part similar to a part for which a search parameter is designated for each of case models registered in a case database; and
a step, executed by a similar structure detecting section, of first extracting, from the part-to-part adjacency relation on the assembly graph as well as from the part searched for in the part search step, a candidate as a starting point of a search in at least one of the registered case models, and then detecting a similar structure matching an adjacency-relation filtering parameter set for each of cases on the basis of the starting point of the search.

5. The similar design structure search method according to claim 4, wherein:
the step of generating the assembly graph focuses attention upon the fastening part and the connection feature and acquires a fastening direction by acquiring a direction of a line normal to an adjacent surface.

6. The similar design structure search method according to claim 4, wherein:
from among at least of an external size value of a bounding box, a center of gravity, principal axes of inertia, a volume, a surface area, a part name, a model name, and the kind of material, at least one part attribute is registered as a search parameter for the designated part registered in the case database.

7. The similar design structure search method according to claim 4, wherein:
in the step of searching for a case model having a similar adjacency relation, extraction is conducted under a condition that at least two combinations of an adjacency direction are similar to each other.

8. The similar design structure search method according to claim 4, wherein:
in the step of searching for a case model having a similar adjacency relation, part types and directions of adjacent parts are analyzed and if the part types are of the same kind and the directions of adjacency are also the same, the number of elements to be searched for is reduced by integrating the elements quantitatively for reduced processing time in the similar search.
